(19) United States
(12) Patent Application Publication
(10) Pub. No.: US 2022/0215235 A1
(43) Pub. Date: Jul. 7, 2022

(54) MEMORY SYSTEM TO TRAIN NEURAL NETWORKS

(71) Applicant: Micron Technology, Inc., Boise, ID (US)

(72) Inventors: Vijay S. Ramesh, Boise, ID (US); Richard C. Murphy, Boise, ID (US)

(21) Appl. No.: 17/143,498

(22) Filed: Jan. 7, 2021

(51) Int. Cl. G06N 3/063; G06N 3/04

(52) U.S. Cl. CPC G06N 3/063; G06N 3/04

(57) ABSTRACT

Methods, systems, and apparatuses related to a memory system to train neural networks are described. For example, data management and training of one or more neural networks may be accomplished within multiple memory devices. Neural networks may thus be trained in the absence of specialized circuitry and/or in the absence of vast computing resources. A method includes performing at least a portion of a training operation for a neural network, on a first memory device, by determining one or more first weights for a hidden layer of the neural network and writing the data corresponding to the neural network to a second memory device. The method further includes performing, using the data corresponding to the neural network written to the second memory device, at least a second portion of the training operation for the neural network by determining one or more second weights for the hidden layer of the neural network.

### TECHNICAL FIELD

The present disclosure relates generally to semiconductor memory and methods, and more particularly, to apparatuses, systems, and methods for a memory system to train neural networks.

### BACKGROUND

Memory devices are typically provided as internal, semiconductor, integrated circuits in computers or other electronic systems. There are many different types of memory including volatile and non-volatile memory. Volatile memory can require power to maintain its data (e.g., host data, error data, etc.) and includes random access memory (RAM), dynamic random access memory (DRAM), static random access memory (SRAM), synchronous dynamic random access memory (SDRAM), and thyristor random access memory (TRAM), among others. Non-volatile memory can provide persistent data by retaining stored data when not powered and can include NAND flash memory, NOR flash memory, and resistance variable memory such as phase change random access memory (PCRAM), resistive random access memory (RRAM), and magnetoresistive random access memory (MRAM), such as spin torque transfer random access memory (STT RAM), among others.

Memory devices may be coupled to a host (e.g., a host computing device) to store data, commands, and/or instructions for use by the host while the computer or electronic system is operating. For example, data, commands, and/or instructions can be transferred between the host and the memory device(s) during operation of a computing or other electronic system.

### BRIEF DESCRIPTION OF THE DRAWINGS

FIG. 1 is a functional block diagram in the form of an apparatus including a host and a memory device in accordance with a number of embodiments of the present disclosure.

FIG. 2A is a functional block diagram in the form of an apparatus including a memory system in accordance with a number of embodiments of the present disclosure.

FIG. 2B is another functional block diagram in the form of an apparatus including a memory system in accordance with a number of embodiments of the present disclosure.

FIG. 3 is a functional block diagram in the form of an apparatus including a memory system that includes a plurality of memory devices in accordance with a number of embodiments of the present disclosure.

FIG. 4 is a flow diagram corresponding to a memory system to train neural networks in accordance with a number of embodiments of the present disclosure.

FIG. 5 is a flow diagram representing an example method corresponding to a memory system to train neural networks in accordance with a number of embodiments of the present disclosure.

### DETAILED DESCRIPTION

Methods, systems, and apparatuses related to a memory system to train neural networks are described. For example, data management and training of one or more neural networks may be accomplished within multiple memory devices of a memory system. Neural networks may thus be trained in the absence of specialized circuitry and/or in the absence of vast computing resources. A method includes performing at least a portion of a training operation for the neural network, on a first memory device, by determining one or more weights for a hidden layer of the neural network and writing the data corresponding to the neural network to a second memory device. The method further includes performing, using the data corresponding to the neural network written to the second memory device, at least a second portion of the training operation for the neural network by determining one or more weights for the hidden layer of the neural network.

A neural network can include a set of instructions that can be executed to recognize patterns in data. Some neural networks can be used to recognize underlying relationships in a set of data in a manner that mimics the way that a human brain operates. A neural network can adapt to varying or changing inputs such that the neural network can generate a best possible result in the absence of redesigning the output criteria.

A neural network can consist of multiple neurons, which can be represented by one or more equations. In the context of neural networks, a neuron can receive a quantity of numbers or vectors as inputs and, based on properties of the neural network, produce an output. For example, a neuron can receive Xₖ inputs, with k corresponding to an index of input. For each input, the neuron can assign a weight vector, Wₖ, to the input. The weight vectors can, in some embodiments, make the neurons in a neural network distinct from one or more different neurons in the network. In some neural networks, respective input vectors can be multiplied by respective weight vectors to yield a value, as shown by Equation 1, which shows and example of a linear combination of the input vectors and the weight vectors.

ƒ(x₁,x₂)=w₁x₁+w₂x₂ Equation 1

In some neural networks, a non-linear function (e.g., an activation function) can be applied to the value ƒ(x₁, x₂) that results from Equation 1. An example of a non-linear function that can be applied to the value that results from Equation 1 is a rectified linear unit function (ReLU). Application of the ReLU function, which is shown by Equation 2, yields the value input to the function if the value is greater than zero, or zero if the value input to the function is less than zero. The ReLU function is used here merely used as an illustrative example of an activation function and is not intended to be limiting. Other non-limiting examples of activation functions that can be applied in the context of neural networks can include sigmoid functions, binary step functions, linear activation functions, hyperbolic functions, leaky ReLU functions, parametric ReLU functions, softmax functions, and/or swish functions, among others.

ReLU(x)=max(x,0) Equation 2

During a process of training a neural network, the input vectors and/or the weight vectors can be altered to “tune” the network. In one example, a neural network can be initialized with random weights. Over time, the weights can be adjusted to improve the accuracy of the neural network. This can, over time yield a neural network with high accuracy.

Neural networks have a wide range of applications. For example, neural networks can be used for system identification and control (vehicle control, trajectory prediction, process control, natural resource management), quantum chemistry, general game playing, pattern recognition (radar systems, face identification, signal classification, 3D reconstruction, object recognition and more), sequence recognition (gesture, speech, handwritten and printed text recognition), medical diagnosis, finance (e.g. automated trading systems), data mining, visualization, machine translation, social network filtering and/or e-mail spam filtering, among others.

Due to the computing resources that some neural networks demand, in some approaches, neural networks are deployed in a computing system, such as a host computing system (e.g., a desktop computer, a supercomputer, etc.) or a cloud computing environment. In such approaches, data to be subjected to the neural network as part of an operation to train the neural network can be stored in a memory resource, such as a NAND storage device, and a processing resource, such as a central processing unit, can access the data and execute instructions to process the data using the neural network. Some approaches may also utilize specialized hardware such a field-programmable gate array or an application-specific integrated circuit as part of neural network training.

In contrast, embodiments herein are directed to data management and training of one or more neural networks within multiple memory devices. For example, embodiments herein are directed to performance of at least a portion of an operation to train a neural network in one memory device (e.g., one type of memory device) followed by performance of at least another portion of the operation to train the neural network in a different memory device (e.g., a different type of memory device). In some embodiments, the memory devices can have different characteristics (e.g., performance characteristics, bandwidth characteristics, capacity characteristics, data retention characteristics, persistence characteristics, etc.) and/or can include different types of media (e.g., media that have different memory cell structures, materials, architectures, etc.).

By performing different stages of neural network training while the neural network is stored in different types of memory devices, training of neural networks can be optimized in comparison to approaches in which the neural network is stored in a same type of memory device during training. For example, by leveraging characteristics of different types of memory devices, as described herein, a neural network can be trained in multiple stages that are performed while the neural network is stored in a memory device that is optimized for each stage of the training process.

One example of this is a neural network that is initially (e.g., partially) trained using a memory device that exhibits high capacity but low bandwidth (e.g., a NAND memory device) and then subsequently trained using a high bandwidth memory (e.g., a 3D stacked SDRAM memory device). By leveraging the capacity of a memory device that exhibits high capacity but low bandwidth, training operations involving large sets of training data can be performed to initially train the neural network. However, once initial training operations have been performed on the neural network, it may be beneficial to write the neural network to a high bandwidth memory device where further training operations can be performed more quickly than in the high capacity memory device. Accordingly, embodiments herein can optimize an amount of time, processing resources, and/or power consumed in training of neural networks by utilizing multiple memory devices during the training process.

In the following detailed description of the present disclosure, reference is made to the accompanying drawings that form a part hereof, and in which is shown by way of illustration how one or more embodiments of the disclosure may be practiced. These embodiments are described in sufficient detail to enable those of ordinary skill in the art to practice the embodiments of this disclosure, and it is to be understood that other embodiments may be utilized and that process, electrical, and structural changes may be made without departing from the scope of the present disclosure.

As used herein, designators such as “N,” “M,” etc., particularly with respect to reference numerals in the drawings, indicate that a number of the particular feature so designated can be included. It is also to be understood that the terminology used herein is for the purpose of describing particular embodiments only, and is not intended to be limiting. As used herein, the singular forms “a,” “an,” and “the” can include both singular and plural referents, unless the context clearly dictates otherwise. In addition, “a number of,” “at least one,” and “one or more” (e.g., a number of memory banks) can refer to one or more memory banks, whereas a “plurality of” is intended to refer to more than one of such things.

Furthermore, the words “can” and “may” are used throughout this application in a permissive sense (i.e., having the potential to, being able to), not in a mandatory sense (i.e., must). The term “include,” and derivations thereof, means “including, but not limited to.” The terms “coupled” and “coupling” mean to be directly or indirectly connected physically or for access to and movement (transmission) of commands and/or data, as appropriate to the context. The terms “data” and “data values” are used interchangeably herein and can have the same meaning, as appropriate to the context.

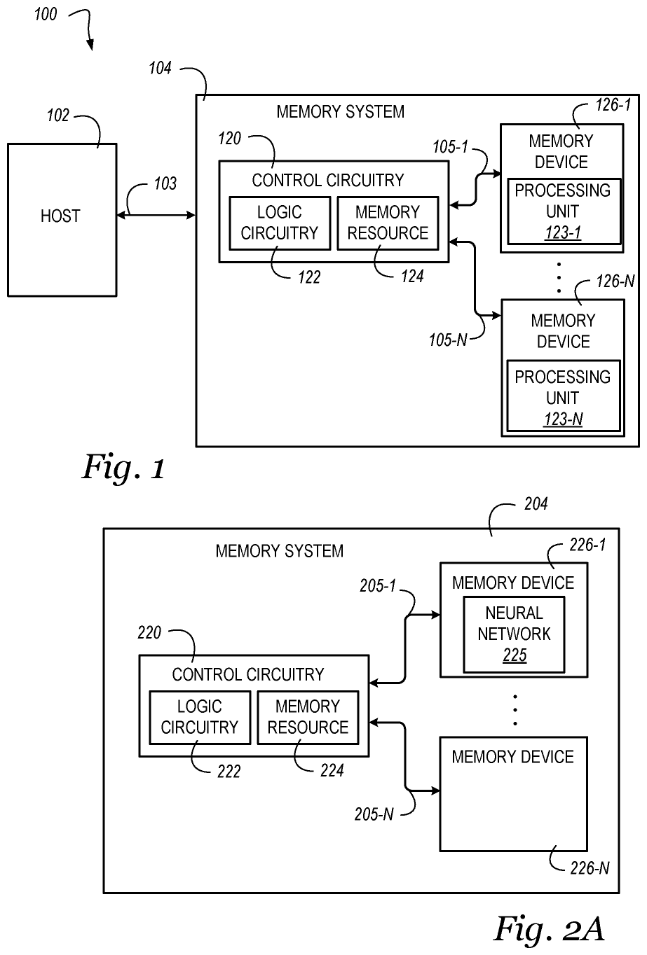

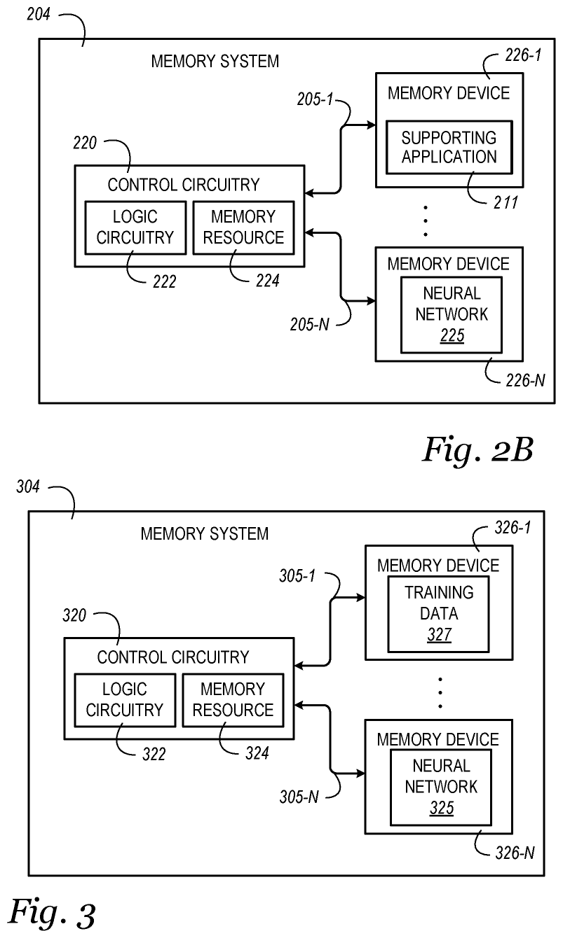

The figures herein follow a numbering convention in which the first digit or digits correspond to the figure number and the remaining digits identify an element or component in the figure. Similar elements or components between different figures may be identified by the use of similar digits. For example, 104 may reference element “04” in FIG. 1, and a similar element may be referenced as 204 in FIG. 2. A group or plurality of similar elements or components may generally be referred to herein with a single element number. For example, a plurality of reference elements 126-1 to 126-N (or, in the alternative, 126-1, . . . , 126-N) may be referred to generally as 126. As will be appreciated, elements shown in the various embodiments herein can be added, exchanged, and/or eliminated so as to provide a number of additional embodiments of the present disclosure. In addition, the proportion and/or the relative scale of the elements provided in the figures are intended to illustrate certain embodiments of the present disclosure and should not be taken in a limiting sense.

FIG. 1 is a functional block diagram in the form of a computing system 100 including an apparatus including a host 102 and a memory system 104 in accordance with a number of embodiments of the present disclosure. As used herein, an “apparatus” can refer to, but is not limited to, any of a variety of structures or combinations of structures, such as a circuit or circuitry, a die or dice, a module or modules, a device or devices, or a system or systems, for example. The memory system 104 can include a number of different memory devices 126-1 to 126-N, which can include one or more memory modules (e.g., single in-line memory modules, dual in-line memory modules, etc.). The memory system 104 can include volatile memory and/or non-volatile memory. In a number of embodiments, memory system 104 can include a multi-chip device. A multi-chip device can include a number of different memory devices 126-1 to 126-N, which can include a number of different memory types and/or memory modules. For example, a memory system can include non-volatile or volatile memory on any type of a module. As shown in FIG. 1, the apparatus 100 can include control circuitry 120, which can include logic circuitry 122 and a memory resource 124. Each of the components (e.g., the host 102, the control circuitry 120, the logic circuitry 122, the memory resource 124, and/or the memory devices 126-1 to 126-N can be separately referred to herein as an “apparatus.” The control circuitry 120 and/or the logic circuitry 122 may be referred to as a “processing device” or “processing unit” herein.

The memory system 104 can provide main memory for the computing system 100 or could be used as additional memory and/or storage throughout the computing system 100. The memory system 104 can include one or more memory devices 126-1 to 126-N, which can include volatile and/or non-volatile memory cells. At least one of the memory devices 126-1 to 126-N can be a flash array with a NAND architecture, for example. Embodiments are not limited to a particular type of memory device. For instance, the memory system 104 can include RAM, ROM, DRAM, SDRAM, PCRAM, RRAM, and flash memory, among others.

In embodiments in which the memory system 104 includes non-volatile memory, the memory system 104 can include any number of memory devices 126-1 to 126-N that can include flash memory devices such as NAND or NOR flash memory devices. Embodiments are not so limited, however, and the memory system 104 can include other non-volatile memory devices 126-1 to 126-N such as non-volatile random-access memory devices (e.g., NVRAM, ReRAM, FeRAM, MRAM, PCM), “emerging” memory devices such as resistance variable (e.g., 3-D Crosspoint (3D XP)) memory devices, memory devices that include an array of self-selecting memory (SSM) cells, etc., or any combination thereof.

Resistance variable memory devices can perform bit storage based on a change of bulk resistance, in conjunction with a stackable cross-gridded data access array. Additionally, in contrast to many flash-based memories, resistance variable non-volatile memory can perform a write in-place operation, where a non-volatile memory cell can be programmed without the non-volatile memory cell being previously erased. In contrast to flash-based memories and resistance variable memories, self-selecting memory cells can include memory cells that have a single chalcogenide material that serves as both the switch and storage element for the memory cell.

In some embodiments, the memory devices 126-1 to 126-N include different types of memory. For example, the memory device 126-1 can be a 3D XP memory device and the memory device 126-N can be a volatile memory device, such as a DRAM device, or vice versa. Embodiments are not so limited, however, and the memory devices 126-1 to 126-N can include any type of memory devices provided that at least two of the memory devices 126-1 to 126-N include different types of memory.

As illustrated in FIG. 1, a host 102 can be coupled to the memory system 104. In a number of embodiments, the memory system 104 can be coupled to the host 102 via one or more channels (e.g., channel 103). In FIG. 1, the memory system 104 is coupled to the host 102 via channel 103 and control circuitry 120 of the memory system 104 is coupled to the memory devices 126-1 to 126-N via channel(s) 105-1 to 105-N. In some embodiments, each of the memory devices 126-1 to 126-N are coupled to the control circuitry 120 by one or more respective channels 105-1 to 105-N such that each of the memory devices 126-1 to 126-N can receive messages, commands, requests, protocols, or other signaling that is compliant with the type of memory device 126-1 to 126-N coupled to the control circuitry 120.

The memory devices 126-1 to 126-N can include respective processing units 123-1 to 123-N. The processing units can be any kind of processor and/or co-processors that are resident on the memory devices 126-1 to 126-N and operable to execute instructions to cause performance of operations involving data that is stored by the memory device 126-1 to 126-N on which the processing unit 123-1 to 123-N is deployed. As used herein, the term “resident on” refers to something that is physically located on a particular component. For example, the processing unit 123-1 to 123-N being “resident on” the memory device 126-1 to 126-N refers to a condition in which a particular processing unit (e.g., the processing unit 123-1) is physically coupled to, or physically within, a particular memory device (e.g., the memory device 126-1). The term “resident on” may be used interchangeably with other terms such as “deployed on” or “located on,” herein

The host 102 can be a host system such as a personal laptop computer, a desktop computer, a digital camera, a smart phone, a memory card reader, and/or an internet-of-things (IoT) enabled device, among various other types of hosts. The host 102 can include a system motherboard and/or backplane and can include a memory access device, e.g., a processor (or processing device). One of ordinary skill in the art will appreciate that “a processor” can intend one or more processors, such as a parallel processing system, a number of coprocessors, etc. The system 100 can include separate integrated circuits or one or more of the host 102, the memory system 104, the control circuitry 120, and/or the memory devices 126-1 to 126-N can be on the same integrated circuit. The computing system 100 can be, for instance, a server system and/or a high-performance computing (HPC) system and/or a portion thereof. Although the example shown in FIG. 1 illustrate a system having a Von Neumann architecture, embodiments of the present disclosure can be implemented in non-Von Neumann architectures, which may not include one or more components (e.g., CPU, ALU, etc.) often associated with a Von Neumann architecture.

The memory system 104, which is shown in more detail in FIG. 2, herein, can include control circuitry 120, which can include logic circuitry 122 and a memory resource 124. The logic circuitry 122 can be provided in the form of an integrated circuit, such as an application-specific integrated circuit (ASIC), field programmable gate array (FPGA), reduced instruction set computing device (RISC), advanced RISC machine, system-on-a-chip, or other combination of hardware and/or circuitry that is configured to perform operations described in more detail, herein. In some embodiments, the logic circuitry 122 can comprise one or more processors (e.g., processing device(s), processing unit(s), etc.)

The logic circuitry 122 can perform operations to control writing of one of more neural networks within the memory devices 126-1 to 126-N, as described in more detail below. In addition to, or in the alternative, the logic circuitry 122 can perform operations to control training and execution of the one or more neural networks written within the memory devices 126-1 to 126-N, as described herein.

In a non-limiting example, the control circuitry 120 can perform operations to control writing of a neural network to a particular memory device (e.g., the memory device 126-1) and/or control performance of various operations to partially train the neural network. Continuing with this example, the control circuitry 120 can perform operations to control writing of the neural network to a different memory device (e.g., the memory device 126-N) and/or control performance of various operations to continue training the neural network. In some embodiments, the particular memory device can be a high capacity memory device, while the different memory device can be a high bandwidth memory device, although embodiments are not so limited. As discussed in more detail herein, the control circuitry 120 can cause performance of such operations to minimize resource consumption of the computing system 100, improve efficiency of training the neural network, and/or leverage characteristics of particular memory devices 126-1 to 126-N that may improve performance in training at least certain portions of the neural network (e.g., the neural network 225 illustrated in FIGS. 2A and 2B, herein).

The control circuitry 120 can further include a memory resource 124, which can be communicatively coupled to the logic circuitry 122. The memory resource 124 can include volatile memory resource, non-volatile memory resources, or a combination of volatile and non-volatile memory resources. In some embodiments, the memory resource can be a random-access memory (RAM) such as static random-access memory (SRAM). Embodiments are not so limited, however, and the memory resource can be a cache, one or more registers, NVRAM, ReRAM, FeRAM, MRAM, PCM), “emerging” memory devices such as resistance variable memory resources, phase change memory devices, memory devices that include arrays of self-selecting memory cells, etc., or combinations thereof. In some embodiments, the memory resource 124 can serve as a cache for the logic circuitry 122.

The embodiment of FIG. 1 can include additional circuitry that is not illustrated so as not to obscure embodiments of the present disclosure. For example, the memory system 104 can include address circuitry to latch address signals provided over I/O connections through I/O circuitry. Address signals can be received and decoded by a row decoder and a column decoder to access the memory system 104 and/or the memory devices 126-1 to 126-N. It will be appreciated by those skilled in the art that the number of address input connections can depend on the density and architecture of the memory system 104 and/or the memory devices 126-1 to 126-N.

FIG. 2A is a functional block diagram in the form of an apparatus including a memory system 204 in accordance with a number of embodiments of the present disclosure. The control circuitry 220, the memory devices 226-1 to 226-N, and/or the neural network 225 can be referred to separately or together as an apparatus. As used herein, an “apparatus” can refer to, but is not limited to, any of a variety of structures or combinations of structures, such as a circuit or circuitry, a die or dice, a module or modules, a device or devices, or a system or systems, for example. The memory system 204 can be analogous to the memory system 104 illustrated in FIG. 1, while the control circuitry 220 can be analogous to the control circuitry 120 illustrated in FIG. 1.

As discussed above, the control circuitry 220 can control writing of the neural network 225 (e.g., an untrained neural network or partially trained neural network) to at least one of the memory devices 226-1 to 226-N. In the example illustrated in FIG. 2A, the control circuitry 220 can control writing of the neural network 225 to the memory device 226-1. Once the neural network 225 is written to (e.g., stored in) the memory device 226-1, the control circuitry 220 (e.g., the logic circuitry 222 of the control circuitry 220) can control performance of operations to train the neural network 225. For example, the control circuitry 220 can perform operations to determine one or more weights for a hidden layer of the neural network 225.

The neural network 225 can be a feed-forward neural network or a back-propagation neural network. Embodiments are not so limited, however, and the neural network 225 can be a perceptron neural network, a radial basis neural network, a deep feed forward neural network, a recurrent neural network, a long/short term memory neural network, a gated recurrent unit neural network, an auto encoder (AE) neural network, a variational AE neural network, a denoising AE neural network, a sparse AE neural network, a Markov chain neural network, a Hopfield neural network, a Boltzmann machine (BM) neural network, a restricted BM neural network, a deep belief neural network, a deep convolution neural network, a deconvolutional neural network, a deep convolutional inverse graphics neural network, a generative adversarial neural network, a liquid state machine neural network, an extreme learning machine neural network, an echo state neural network, a deep residual neural network, a Kohonen neural network, a support vector machine neural network, and/or a neural Turing machine neural network, among others.

In some embodiments, the control circuitry 220 can perform operations to determine one or more first weights for a hidden layer of the neural network 225 as part of performance of operations to at least partially train the neural network 225. That is, in some embodiments, the control circuitry 220 can perform operations to partially but not fully train the neural network 225 while the neural network 225 is stored within the memory device 226-1. In embodiments in which the control circuitry 220 performs operations to partially train the neural network 225 while the neural network 225 is stored in the memory device 226-1, the control circuitry 220 can, prior to writing the neural network 225 to the memory device 226-1, determine that characteristics of the memory device 226-1 are conducive for partially training the neural network 225.

That is, in some embodiments, at least a portion of the operation to train the neural network 225 within the memory device 226-1 to can be performed while the neural network 225 is stored within the memory device 226-1 based on characteristics of the memory device 226-1 such as the type of media employed by the memory device 226-1, the bandwidth of the memory device 226-1, and/or the speed of the memory device 226-1, among others. In some embodiments, once the operation(s) to train the neural network 225 have been initiated, training operations can be performed within the memory device 226-1 in the absence of additional commands from the control circuitry 220 and/or a host (e.g., the host 102 illustrated in FIG. 1, herein).

In some embodiments, the control circuitry 220 can control, in the absence of signaling generated by circuitry external to the memory system 204, performance of the operations to cause the untrained or partially trained neural network 225 to be trained. By performing neural network training in the absence of signaling generated by circuitry external to the memory system 204 (e.g., by performing neural network training within the memory system 204 or “on chip”), data movement to and from the memory system 204 can be reduced in comparison to approaches that do not perform neural network training within the memory system 204. This can allow for a reduction in power consumption in performing neural network training operations and/or a reduction in dependence on a host computing system (e.g., the host 102 illustrated in FIG. 1). In addition, neural network training can be automized, which can reduce an amount of time spent in training the neural network 225.

As used herein, “neural network training operations” or “operations to train the neural network,” as well as variants thereof, include operations that are performed to determine one or more hidden layers of at least one neural network. In general, a neural network can include at least one input layer, at least one hidden layer, and at least one output layer. The layers can include multiple neurons that can each receive an input and generate a weighted output. In some embodiments, the neurons of the hidden layer(s) can calculate weighted sums and/or averages of inputs received from the input layer(s) and their respective weights and pass such information to the output layer(s).

In some embodiments, the neural network training operations can be performed by utilizing knowledge learned by a trained neural network during their training to train an untrained neural network. This can reduce the amount of time and resources spent in training untrained neural networks by reducing retraining of information that has already been learned by a trained neural network. In addition, embodiments herein can allow for a neural network that has been trained under a particular training methodology to train an untrained neural network with a different training methodology. For example, a neural network can be trained under a Tensorflow methodology and can then train an untrained neural network under a MobileNet methodology (or vice versa). Embodiments are not limited to these specific examples, however, and other training methodologies are contemplated within the scope of the disclosure.

The control circuitry 220 can, in some embodiments, cause performance of operations to convert data associated with the neural network 225 (e.g., the untrained neural network and/or the partially neural network) from one data type to another data type prior to causing the untrained and/or partially trained neural network 225 to be stored in the memory devices 226-1 to 226-N and/or prior to transferring the neural network 225 to circuitry external to the memory system 204. As used herein, a “data type” generally refers to a format in which data is stored. Non-limiting examples of data types include the IEEE 754 floating-point format, the fixed-point binary format, and/or universal number (unum) formats such as Type III unums and/or posits. Accordingly, in some embodiments, the control circuitry 220 can cause performance of operations to convert data associated with the neural networks (e.g., the untrained neural network and/or the partially trained neural network) from a floating-point or fixed point binary format to a universal number or posit format prior to causing the untrained and/or partially trained neural network to be stored in the memory devices 226-1 to 226-N and/or prior to transferring the neural networks to circuitry external to the memory system 204.

In contrast to the IEEE 754 floating-point or fixed-point binary formats, which include a sign bit sub-set, a mantissa bit sub-set, and an exponent bit sub-set, universal number formats, such as posits include a sign bit sub-set, a regime bit sub-set, a mantissa bit sub-set, and an exponent bit sub-set. This can allow for the accuracy, precision, and/or the dynamic range of a posit to be greater than that of a float, or other numerical formats. In addition, posits can reduce or eliminate the overflow, underflow, NaN, and/or other corner cases that are associated with floats and other numerical formats. Further, the use of posits can allow for a numerical value (e.g., a number) to be represented using fewer bits in comparison to floats or other numerical formats.

In some embodiments, the control circuitry 220 can determine that the untrained or partially trained neural network 225 has been trained and cause the neural network 225 that has been trained to be transferred to circuitry external to the memory system 204. Further, in some embodiments, the control circuitry 220 can determine that the untrained and/or partially trained neural network 225 has been trained and cause performance of an operation to alter a precision, a dynamic range, or both, of information (e.g., data) associated with the neural network 225 that has been trained. Embodiments are not so limited, however, and in some embodiments, the control circuitry 220 can cause performance of an operation to alter a precision, a dynamic range, or both, of information (e.g., data) associated with the untrained and/or partially trained neural network 225 prior to the untrained and/or partially trained neural network 225 being stored in the memory devices 226-1 to 226-N.

As used herein, a “precision” refers to a quantity of bits in a bit string that are used for performing computations using the bit string. For example, if each bit in a 16-bit bit string is used in performing computations using the bit string, the bit string can be referred to as having a precision of 16 bits. However, if only 8-bits of a 16-bit bit string are used in performing computations using the bit string (e.g., if the leading 8 bits of the bit string are zeros), the bit string can be referred to as having a precision of 8-bits. As the precision of the bit string is increased, computations can be performed to a higher degree of accuracy. Conversely, as the precision of the bit string is decreased, computations can be performed using to a lower degree of accuracy. For example, an 8-bit bit string can correspond to a data range consisting of two hundred and fifty-five (256) precision steps, while a 16-bit bit string can correspond to a data range consisting of sixty-five thousand five hundred and thirty-six (63,536) precision steps.

As used herein, a “dynamic range” or “dynamic range of data” refers to a ratio between the largest and smallest values available for a bit string having a particular precision associated therewith. For example, the largest numerical value that can be represented by a bit string having a particular precision associated therewith can determine the dynamic range of the data format of the bit string. For a universal number (e.g., a posit) format bit string, the dynamic range can be determined by the numerical value of the exponent bit sub-set of the bit string.

A dynamic range and/or the precision can have a variable range threshold associated therewith. For example, the dynamic range of data can correspond to an application that uses the data and/or various computations that use the data. This may be due to the fact that the dynamic range desired for one application may be different than a dynamic range for a different application, and/or because some computations may require different dynamic ranges of data. Accordingly, embodiments herein can allow for the dynamic range of data to be altered to suit the requirements of disparate applications and/or computations. In contrast to approaches that do not allow for the dynamic range of the data to be manipulated to suit the requirements of different applications and/or computations, embodiments herein can improve resource usage and/or data precision by allowing for the dynamic range of the data to varied based on the application and/or computation for which the data will be used.

FIG. 2B is another functional block diagram in the form of an apparatus including a memory system 204 in accordance with a number of embodiments of the present disclosure. The control circuitry 220, the memory devices 226-1 to 226-N, and/or the neural network 225 can be referred to separately or together as an apparatus. As used herein, an “apparatus” can refer to, but is not limited to, any of a variety of structures or combinations of structures, such as a circuit or circuitry, a die or dice, a module or modules, a device or devices, or a system or systems, for example. The memory system 204 can be analogous to the memory system 104/204 illustrated in FIGS. 1 and 2A, while the control circuitry 220 can be analogous to the control circuitry 120/220 illustrated in FIGS. 1 and 2A.

The example illustrated in FIG. 2B corresponds to a scenario in which the neural network has been written to the memory device 226-N. For example, in FIG. 2B, at least a portion of an operation to train the neural network 225 has been performed while the neural network 225 was stored in the memory device 226-1, as described in connection with FIG. 2A, and the partially trained neural network 225 has been written to the memory device 226-N for subsequent training.

In some embodiments, the control circuitry 220 can determine that subsequent training of the neural network 225 can be performed more efficiently while the neural network 225 is stored in the memory device 226-N as opposed to the memory device 226-1. In such embodiments, the control circuitry 220 can cause the partially trained neural network 225 to be written to the memory device 226-N. Once the partially trained neural network 225 has been written to the memory device 226-N, the control circuitry 220 can control performance of operations to further train the partially trained neural network 225. For example, the control circuitry 220 can perform operations to determine one or more weights for a hidden layer of the neural network 225 as part of a neural network training operation.

In some embodiments, the control circuitry 220 can perform operations to determine one or more second weights for a hidden layer of the neural network 225 as part of performance of operations to further train the neural network 225. That is, in some embodiments, the control circuitry 220 can perform operations to finish training a partially trained neural network 225 while the neural network 225 is stored within the memory device 226-N. In embodiments in which the control circuitry 220 performs operations to finish training the neural network 225 while the neural network 225 is stored in the memory device 226-N, the control circuitry 220 can, prior to writing the neural network 225 to the memory device 226-N, determine that characteristics of the memory device 226-N are conducive to finishing training of the neural network 225.

That is, in some embodiments, at least a portion of the operation to train the neural network 225 within the memory device 226-N to can be performed while the neural network 225 is stored within the memory device 226-N based on characteristics of the memory device 226-N such as the type of media employed by the memory device 226-N, the bandwidth of the memory device 226-N, and/or the speed of the memory device 226-N, among others. In some embodiments, once the operation(s) to train the neural network 225 have been initiated, training operations can be performed within the memory device 226-N in the absence of additional commands from the control circuitry 220 and/or a host (e.g., the host 102 illustrated in FIG. 1, herein).

As shown in FIG. 2B, the memory device 226-1 can be configured to execute a supporting application 211 as part of performance of the operation(s) to train the neural network. As used herein, the term “supporting application” generally refers to an executable computing application (e.g., a computing program) that can assist in performance of the operations described herein. For example, the supporting application 211 can coordinate performance of at least a portion of the neural network training operations described herein. Although shown as being resident on the memory device 226-1, embodiments are not so limited, and a supporting application 211 can also be executed on the memory device 226-N.

In a non-limiting example, an apparatus (e.g., the memory system 204) can include a first memory device (e.g., the memory device 226-1) and a second memory device (e.g., the memory device 226-N). As described herein, the first memory device and the second memory device can exhibit different bandwidth, power consumption, capacity, and/or latency characteristics. A processing device (e.g., the control circuitry 220 and/or the logic circuitry 222) can be coupled to the memory device 226-1 and the memory device 226-N. The processing device can cause performance of at least a first portion of a training operation for a neural network 225 written to the first memory device 226-1 by determining one or more first weights for a hidden layer of the neural network 225.

The processing device can then write data corresponding to the neural network 225 to the second memory device 226-N subsequent to performance of at least the first portion of the training operation and cause performance of at least a second portion of the training operation for the neural network 225 written to the second memory device 226-N by determining one or more second weights for the hidden layer of the neural network 225. The processing device can further write data corresponding to the neural network 225 to the first memory device 226-1 subsequent to performance of at least the second portion of the training operation and/or cause performance of at least a third portion of the training operation for the neural network 225 written to the first memory device 226-1 by determining one or more third weights for the hidden layer of the neural network 225.

Continuing with this example, the processing device can cause performance of at least the first portion of the training operation as part of performance of a first level of training the neural network 225 and/or cause performance of at least the second portion of the training operation as part of performance of a second level of training the neural network 225. As used herein, the terms “first level of training” and “second level of training,” as well as variants thereof, generally refer to performance of a particular quantity of iterations of a training operation that may not correspond to the neural network being fully trained. For example, a first level of training can refer to the performance of a first quantity of iterations of a neural network training operation after which the neural network is partially (e.g., not fully) trained. The second level of training can refer to the performance of a second quantity of iterations of a neural network training operation after which the neural network is either partially (e.g., not fully) or fully trained.

In some embodiments, the first memory device 226-1 can have a processing unit (e.g., the processing unit 123-1 illustrated in FIG. 1) resident thereon and/or the second memory device 226-N can have a processing unit (e.g., the processing unit 123-N illustrated in FIG. 1) resident thereon. In such embodiments, the processing unit (e.g., the processing unit 123-1) can cause performance of an operation to pre-process data corresponding with the neural network 225 prior to the data corresponding to the neural network 225 being written to the second memory device 226-N. For example, the processing unit can perform an operation to normalize data (e.g., vectors) associated with the neural network 225 prior to the neural network 225 being written to the second memory device 226-N. Embodiments are no so limited, however, and in some embodiments, the processing unit can perform image segmentation, feature extraction, and/or operations to alter, reduce, compress, or otherwise modify at least a portion of the data associated with the neural network 225 prior to the neural network 225 being written to the second memory device 226-N.

The processing device can, in some embodiments, write a copy of data corresponding to a first data state associated with the neural network 225 to the first memory device 226-1 or the second memory device 226-N, or both and determine that the first data state associated with the neural network written to the first memory device 226-1 or the second memory device 226-N, or both, has been updated to a second data state associated with the neural network 225. In response to such a determination, the processing device can delete the copy of the data corresponding to the first data state in response to determining that the first data state has been updated to the second data state.

In this manner, checkpointing operations can be implemented by the apparatus to ensure that a recoverable copy of the neural network 225 is available in the event of a failure of the apparatus or a portion thereof. For example, in some embodiments, the processing device can determine that an error involving the neural network 225 has occurred, retrieve a copy of data corresponding to the second data state from the first memory device 226-1 or the second memory device 226-N, or both, and perform an operation to recover the neural network 225 using the copy of the data corresponding to the second data state.

In addition to, or in the alternative, the processing device can perform page swapping operations involving the first memory device 226-1 and/or the second memory device 226-N to transfer the neural network 225 between the first memory device 226-1 and the second memory device 226-N, or vice versa to perform different portions of training operations for the neural network 225. This can allow for performance of training operations involving the neural network 225 to be optimized by selecting the best available memory device for each level of training the neural network 225.

In another non-limiting example, a system (e.g., the computing system 100 illustrated in FIG. 1) can include control circuitry 220 comprising a processing device (e.g., the logic circuitry 222) and a memory resource 224 configured to operate as a cache for the processing device and a plurality of memory devices 226-1 to 226-N coupled to the control circuitry 220. In this example, the control circuitry 220 can write data corresponding to a neural network 225 to a first memory device (e.g., the memory device 226-1) among the plurality of memory devices 226-1 to 226-N and cause, while the neural network 225 is stored in the first memory device 226-1, at least a first portion of a training operation for a neural network 225 by determining one or more first weights for a hidden layer of the neural network 225 to be performed. The control circuitry 220 can then write the data corresponding to the neural network 225 to a second memory device (e.g., the memory device 226-N) and cause, while the neural network 225 is stored in the second memory device, at least a second portion of the training operation for the neural network 225 by determining one or more second weights for the hidden layer of the neural network 225 to be performed.

Continuing with this example, the control circuitry 220 can write the data corresponding to the neural network 225 to the first memory device based on a determination that at least one characteristic of the first memory device 226-1 meets a first set of criterion and/or write the data corresponding to the neural network 225 to the second memory device 226-N based on a determination that at least one characteristic of the second memory device 226-N meets a second set of criterion. The characteristics and/or the criterion for writing the neural network 225 to the first memory device 226-1 or the second memory device 226-N can include a bandwidth associated with the first memory device 226-1 and the second memory device 226-N, a latency associated with the first memory device 226-1 and the second memory device 226-N, and/or a capacity associated with the first memory device 226-1 and the second memory device 226-N, among other characteristics and/or criterion associated with the first memory device 226-1 and the second memory device 226-N.

In some embodiments, the control circuitry 220 can write a copy of data corresponding to a first data state associated with the neural network 225 to the first memory device 226-1 or the second memory device 226-N, or both. The control circuitry 220 can then determine that the first data state associated with the neural network 225 written to the first memory device 226-1 or the second memory device 226-N, or both, has been updated to a second data state associated with the neural network 225. The control circuitry 220 can then delete the copy of the data corresponding to the first data state in response to determining that the first data state has been updated to the second data state. In some embodiments, the control circuitry 220 can determine that an error involving the neural network 225, the memory devices 226-1 to 226-N and/or the memory system 204 has occurred and retrieve a copy of data corresponding to the second data state from the first memory device 226-1 or the second memory device 226-N, or both. The control circuitry 220 can then perform an operation to recover the neural network using the copy of the data corresponding to the second data state.

Continuing with this example, in some embodiments, the control circuitry 220 can, subsequent to writing the data corresponding to the neural network 225 to the second memory device 226-N, write observed data to the first memory device 226-1, or vice versa. The control circuitry can then execute the neural network 225 on the second memory device 226-N using the observed data written to the first memory device 226-1. The observed data can, in some embodiments, include training data that is gathered from real world events and can be gathered through various sensors such as biochemical sensors, image sensors, and/or monitoring sensors, among others.

FIG. 3 is a functional block diagram in the form of an apparatus including a memory system 304 that includes a plurality of memory devices 326-1 to 326-N in accordance with a number of embodiments of the present disclosure. The control circuitry 320, the memory devices 326-1 to 326-N, and/or the neural network 325 can be referred to separately or together as an apparatus. The memory system 304 can be analogous to the memory system 104/204 illustrated in FIGS. 1 and 2A-2B, while the control circuitry 320 can be analogous to the control circuitry 120/220 illustrated in FIGS. 1 and 2A-2B.

As shown in FIG. 3, training data 327 is stored by the memory device 226-1. The training data 327 can be analogous to the observed data described above in connection with FIG. 2B. That is, in some embodiments, the training data 327 can include training data 327 that is gathered from real world events and can be gathered through various sensors such as biochemical sensors, image sensors, and/or monitoring sensors, among others. Although shown as being stored in the memory device 326-1, embodiments are not so limited and, in some embodiments, the training data 327 (or at least a portion thereof) can be stored in the memory device 326-N.

The memory device 326-1 to 326-N in which the training data 327 is stored can be based on characteristics of the memory device 326-1 to 326-N in which the training data 327 is stored and at least one of the other memory devices 326-1 to 326-N. For example, the training data 327 may be stored in the memory device 326-1 based on a determination that the memory device 326-1 has a higher capacity, lower bandwidth, and/or a higher latency than the memory device 326-N. In addition to, or in the alternative, the training data may be stored in a memory device 326-1 to 326-N that is not currently storing the neural network 325, although embodiments are not so limited.

In some embodiments, the training data 327 can be used to at least partially train the neural network 325. That is, the training data 327 can be included in an input layer associated with the neural network 325 and can therefore be used in connection with determining one or more hidden layers of the neural network 325.

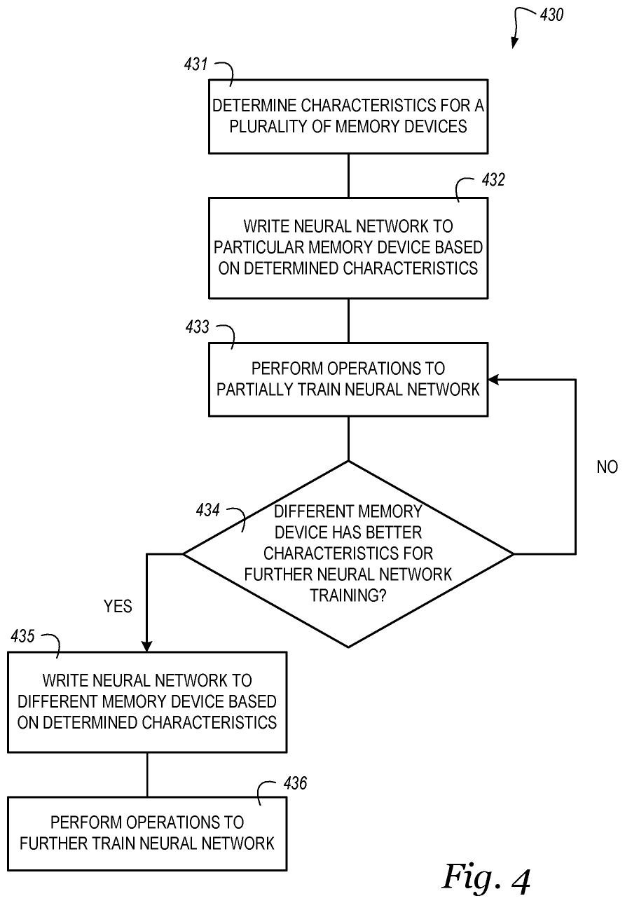

FIG. 4 is a flow diagram 430 corresponding to a memory system to train neural networks in accordance with a number of embodiments of the present disclosure. The flow 430 can be performed by processing logic that can include hardware (e.g., processing device(s), control circuitry, dedicated logic, programmable logic, microcode, hardware of a device, and/or integrated circuit(s), etc.), software (e.g., instructions run or executed on a processing device), or a combination thereof. In some embodiments, the flow 430 is performed by control circuitry (e.g., the control circuitry 120 illustrated in FIG. 1). Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 431, a determination can be made with respect to characteristics of multiple memory devices (e.g., the memory devices 126-1 to 126-N illustrated in FIG. 1, herein). As described above, the characteristics can include bandwidth associated with the memory devices, latencies associated with the memory devices, capacities associated with the memory devices, media types associated with the memory devices, power consumption levels associated with the memory devices, and/or data retention characteristics associated with the memory devices, among others.

At operation 432, a neural network (e.g., the neural network 225 illustrated in FIGS. 2A and 2B) is written to a particular memory device based on the determined characteristics. Once the neural network has been written to the particular memory device, at operation 433, operations to partially train the neural network can be performed. As described above, in some embodiments, the operations to partially train the neural network can include operations to determine hidden layers for the neural network.

At operation 434, a determination can be made as to whether a different memory device has better characteristics than the particular memory device for further training the neural network. For example, it may be determined that characteristics of a different memory device may be more suited to performing further training operations on the partially trained neural network. If it is determined that a different memory device does not have better characteristics for further training the neural network, the flow 430 can return to operation 433 and operations to partially train the neural network can commence.

If, however, it is determined that a different memory device has better characteristics than the particular memory device for further training the neural network, at operation 435, the partially trained neural network can be written to the different memory device. Once the partially trained neural network has been written to the different memory device, at operation 436, operations to further train the partially trained neural network can be performed.

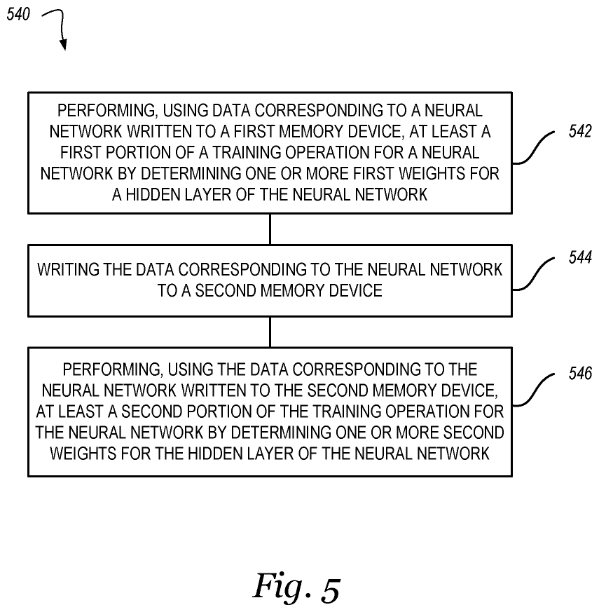

FIG. 5 is a flow diagram representing an example method 540 corresponding to a memory system to train neural networks in accordance with a number of embodiments of the present disclosure. The method 540 can be performed by processing logic that can include hardware (e.g., processing device(s), control circuitry, dedicated logic, programmable logic, microcode, hardware of a device, and/or integrated circuit(s), etc.), software (e.g., instructions run or executed on a processing device), or a combination thereof. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At block 542, the method 540 can include performing, using data corresponding to a neural network written to a first memory device, at least a first portion of a training operation for a neural network (e.g., the neural network 225 illustrated in FIGS. 2A and 2B) by determining one or more first weights for a hidden layer of the neural network. In some embodiments, the first memory device can be analogous to the memory device 126-1 illustrated in FIG. 1.

At block 544, the method 540 can include writing the data corresponding to the neural network to a second memory device. In some embodiments, the second memory device can be analogous to the memory device 126-N illustrated in FIG. 1. In some embodiments, the method 540 can include performing, prior to writing the data corresponding to the neural network to the second memory device, an operation to reduce a quantity of data associated with the neural network, an image segmentation operation using the neural network, or any other operation involving the neural network.

In some embodiments, the method 540 can include receiving, by the first memory device, training data corresponding to the neural network and/or providing the training data to an input layer of the neural network. The method can further include writing, within the first memory device or the second memory device, or both, data associated with an output (e.g., an output layer) of the neural network.

The method 540 can further include performing, prior to writing the data corresponding to the neural network to the second memory device, an operation to select particular vectors from the data corresponding to the neural network and/or writing the particular vectors from the data corresponding to the neural network to the second memory device. For example, a processing unit (e.g., the processing units 123-1 to 123-N illustrated in FIG. 1) resident on the memory devices can perform operations to, as described above, pre-process data associated with the neural network prior to transferring the neural network to the second memory device.

At block 546, the method 540 can include performing, using the data corresponding to the neural network written to the second memory device, at least a second portion of the training operation for the neural network by determining one or more second weights for the hidden layer of the neural network. As described above, the first memory device or the second memory device has a higher data processing bandwidth than the other of the first memory device or the second memory device.

As described above, in some embodiments, the method 540 can include storing a copy of the data corresponding to a first state of the neural network in the first memory device and/or the second memory device. Determining that the first state of the neural network has been updated to a second state of the neural network. Deleting the copy of the data corresponding to the first state of the neural network in response to determining that the first state of the neural network has been updated to the second state.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and processes are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
performing, on a first memory device and using data corresponding to a neural network written to the first memory device, at least a first portion of a training operation for a neural network by determining one or more first weights for a hidden layer of the neural network;
writing the data corresponding to the neural network to a second memory device; and
performing, on the second memory device and using the data corresponding to the neural network written to the second memory device, at least a second portion of the training operation for the neural network by determining one or more second weights for the hidden layer of the neural network.

2. The method of claim 1, further comprising:
receiving, by the first memory device, training data corresponding to the neural network;
providing the training data to an input layer of the neural network; and
writing, within the first memory device or the second memory device, or both, data associated with an output of the neural network.

3. The method of claim 1, further comprising performing, prior to writing the data corresponding to the neural network to the second memory device, an operation to reduce a quantity of data associated with the neural network.

4. The method of claim 1, further comprising performing, prior to writing the data corresponding to the neural network to the second memory device, an image segmentation operation using the neural network.

5. The method of claim 1, further comprising:
performing, prior to writing the data corresponding to the neural network to the second memory device, an operation to select particular vectors from the data corresponding to the neural network; and
writing the particular vectors from the data corresponding to the neural network to the second memory device.

6. The method of claim 1, wherein the first memory device or the second memory device has a higher data processing bandwidth than the other of the first memory device or the second memory device.

7. The method of claim 1, further comprising:
storing a copy of the data corresponding to a first state of the neural network in the first memory device or the second memory device, or both;
determining that the first state of the neural network has been updated to a second state of the neural network; and
deleting the copy of the data corresponding to the first state of the neural network in response to determining that the first state of the neural network has been updated to the second state.

8. An apparatus, comprising:
a first memory device;
a second memory device coupled to the first memory device; and
a processing device coupled to the first memory device and the second memory device, the processing device to:
cause performance of at least a first portion of a training operation for a neural network written to the first memory device by determining one or more first weights for a hidden layer of the neural network;
write data corresponding to the neural network to the second memory device subsequent to performance of at least the first portion of the training operation; and
cause performance of at least a second portion of the training operation for the neural network written to the second memory device by determining one or more second weights for the hidden layer of the neural network.

9. The apparatus of claim 8, wherein:
the first memory device has a first bandwidth associated therewith and
the second memory device has a second bandwidth associated therewith, the second bandwidth being greater than the first bandwidth.

10. The apparatus of claim 8, wherein the processing device is to:
cause performance of at least the first portion of the training operation as part of performance of a first level of training the neural network; and
cause performance of at least the second portion of the training operation as part of performance of a second level of training the neural network.

11. The apparatus of claim 8, wherein the first memory device comprises a processing unit resident thereon, and wherein the processing unit is to cause performance of an operation to pre-process data corresponding with the neural network prior to the data corresponding to the neural network being written to the second memory device.

12. The apparatus of claim 8, wherein the processing device is to:
write data corresponding to the neural network to the first memory device subsequent to performance of at least the second portion of the training operation; and
cause performance of at least a third portion of the training operation for the neural network written to the first memory device by determining one or more third weights for the hidden layer of the neural network.

13. The apparatus of claim 8, wherein the processing device is to:
write a copy of data corresponding to a first data state associated with the neural network to the first memory device or the second memory device, or both;
determine that the first data state associated with the neural network written to the first memory device or the second memory device, or both, has been updated to a second data state associated with the neural network; and
delete the copy of the data corresponding to the first data state in response to determining that the first data state has been updated to the second data state.

14. The apparatus of claim 13, wherein the processing device is to:
determine that an error involving the neural network has occurred;
retrieve a copy of data corresponding to the second data state from the first memory device or the second memory device, or both; and
perform an operation to recover the neural network using the copy of the data corresponding to the second data state.

15. A system, comprising:
control circuitry comprising a processing device and a memory resource configured to operate as a cache for the processing device; and
a plurality of memory devices coupled to the control circuitry, wherein the control circuitry is to:
write data corresponding to a neural network to a first memory device among the plurality of memory devices;
cause, while the neural network is stored in the first memory device, at least a first portion of a training operation for the neural network by determining one or more first weights for a hidden layer of the neural network to be performed;
write the data corresponding to the neural network to a second memory device; and
cause, while the neural network is stored in the second memory device, at least a second portion of the training operation for the neural network by determining one or more second weights for the hidden layer of the neural network to be performed.

16. The system of claim 15, wherein the control circuitry is to:
write the data corresponding to the neural network to the first memory device based on a determination that at least one characteristic of the first memory device meets a first set of criterion; and
write the data corresponding to the neural network to the second memory device based on a determination that at least one characteristic of the second memory device meets a second set of criterion.

17. The system of claim 15, wherein the control circuitry is to:
write a copy of data corresponding to a first data state associated with the neural network to the first memory device or the second memory device, or both;
determine that the first data state associated with the neural network written to the first memory device or the second memory device, or both, has been updated to a second data state associated with the neural network;
delete the copy of the data corresponding to the first data state in response to determining that the first data state has been updated to the second data state;
determine that an error involving the neural network has occurred;
retrieve a copy of data corresponding to the second data state from the first memory device or the second memory device, or both; and
perform an operation to recover the neural network using the copy of the data corresponding to the second data state.

18. The system of claim 15, wherein the first memory device has a first bandwidth associated therewith and the second memory device has a second bandwidth associated therewith, the first bandwidth being lower than the second bandwidth.

19. The system of claim 15, wherein the first memory device has a first capacity associated there and the second memory device has a second capacity associated therewith, the first capacity being greater than the second capacity.

20. The system of claim 15, wherein the first memory device has a first latency associated there and the second memory device has a second latency associated therewith, the first latency being greater than the second latency.

21. The system of claim 15, wherein the control circuitry is to:
subsequent to writing the data corresponding to the neural network to the second memory device, write observed data to the first memory device; and
execute the neural network on the second memory device using the observed data written to the first memory device.
